(19) United States
(12) Patent Application Publication
(10) Pub. No.: US 2025/0125702 A1
(43) Pub. Date: Apr. 17, 2025

(54) DIRECT DRIVE TRANSMISSION SYSTEM

(71) Applicant: AAC Microtech (Changzhou) Co., Ltd., Changzhou City,Jiangsu Province (CN)

(72) Inventors: Yu Qin, Shenzhen (CN); Weiling Shi, Shenzhen (CN); Shun Guo, Shenzhen (CN); Wanlun Wang, Shenzhen (CN)

(21) Appl. No.: 17/915,506

(22) PCT Filed: Jul. 21, 2022
(86) PCT No.: PCT/CN2022/106915

§ 371 Date: Sep. 29, 2022

(30) Foreign Application Priority Data
Jun. 30, 2022 (CN) 202221695811.4

(51) Int. Cl. H02K 41/03

(52) U.S. Cl. CPC H02K 41/03

(57) ABSTRACT

The present disclosure provides direct drive transmission system, including primary assembly and secondary assembly. The primary assembly includes connection unit, first primary unit, and second primary unit. The secondary assembly includes first secondary unit and second secondary unit. The connection unit includes first and second ends opposite to each other. First primary units are sequentially distributed on first end of connection unit. Second primary units are sequentially distributed on second end of connection unit. The secondary assembly is movable relative to primary assembly. The first primary unit faces first secondary unit. The second primary unit faces second secondary unit. A first magnetic field loop is formed between first primary unit and first secondary unit. A second magnetic field loop is formed between second primary unit and second secondary unit. The direct drive transmission system is reasonable in structure design, is fixed in simple manner, and has good dynamic performance.

### TECHNICAL FIELD

The present disclosure relates to the technical field of motor drive, and in particular, to a direct drive transmission system.

### BACKGROUND

Direct drive is a direct combination of a new motor with a motion execution part. That is, the motor directly drives a machine to run, without any intermediate mechanical transmission link. Direct drive is applied to a linear moving component with a linear motor as a core driving element and a rotary moving component with a torque motor as a core driving element.

A current direct drive transmission system has the following advantages.

1. In terms of equipment life, the direct drive system reduces mechanical transmission parts, reduces wear and tear, improves the equipment life, and saves energy.

2. The direct drive system eliminates mechanical transmission, which reduces a failure rate and can saves part and manufacturing costs, thereby reducing overall equipment costs.

3. The direct drive system greatly improves equipment machining efficiency and effectively improves machining accuracy.

However, the current direct drive transmission system also has the following disadvantages.

In order to form a magnetic field loop between the primary assembly fixed to the stator and the secondary assembly fixed to the rotor to cause energized coils of the primary assembly to interact with the magnetic field loop to drive the rotor to move along a preset trajectory, the coils and the cores of the primary assembly are required to be potted and fixed by mounting parts, and then the primary assembly is fixed to the stator, which leads to complicated fixing of the primary assembly and inconvenient assembly.

### SUMMARY

The present disclosure is intended to provide a new technical solution of a direct drive transmission system, so as to solve at least one of the technical problems existing in the related art.

According to one aspect of the present disclosure, a direct drive system is provided, including a primary assembly and a secondary assembly, wherein the primary assembly includes a connection unit, a first primary unit, and a second primary unit; and the secondary assembly includes a first secondary unit and a second secondary unit;

the connection unit including a first end and a second end opposite to each other; a plurality of first primary units being sequentially distributed on the first end of the connection unit, a plurality of second primary units being sequentially distributed on the first end of the connection unit, the connection unit being configured to fix the primary assembly; and

the secondary assembly is movable relative to the primary assembly, the first primary unit faces the first secondary unit, the second primary unit faces the second secondary unit, a first magnetic field loop is formed between the first primary unit and the second secondary unit, and a second magnetic field loop is formed between the second primary unit and the second secondary unit.

As an improvement, each of the first primary units includes a first iron core and a first coil;
one end of the first iron core being fixed to the first end of the connection unit, and the first coil sleeving the other end of the first iron core;
and/or each of the second primary units includes a second iron core and a second coil;
one end of the second iron core being fixed to the second end of the connection unit, and the second coil sleeving the other end of the second iron core.

As an improvement, the first iron core, the connection unit, and the second iron core are formed into one piece.

As an improvement, the first secondary unit includes a first magnetic yoke and first magnets; an even number of first magnets being arranged on the first magnetic yoke, adjacent first magnets having different polarity, and the first magnets facing the first iron core; and
the second secondary unit includes a second magnetic yoke and second magnets; an even number of second magnets being arranged on the second magnetic yoke, adjacent second magnets having different polarity, and the second magnets facing the second iron core.

As an improvement, the direct drive transmission system further includes a rotor, the rotor being provided with a groove, the groove including a first inner side surface and a second inner side surface opposite to each other, the first secondary unit being arranged on the first inner side surface, and the second secondary unit being arranged on the second inner side surface;
at least part of the primary assembly being embedded into the groove.

As an improvement, the direct drive transmission system further includes a base and a support, the support being fixed to the base, and the connection unit being fixed to the support.

As an improvement, the connection unit is provided with a plurality of spaced mounting holes, a bolt passing through the mounting hole to fix the primary assembly to the support.

As an improvement, the direct drive transmission system further includes a limiting assembly, the limiting assembly including a slider and a guide rail;
the guide rail being fixed to the base, the first primary units or the second primary units being distributed along a first direction, the guide rail extending along the first direction; the slider being fixed to the rotor, the slider being mounted on the guide rail and movable along an extension direction of the guide rail.

As an improvement, at least part of the first direction is a linear direction.

As an improvement, the slider includes a first chute and a second chute opposite to each other, and the guide rail includes a first bulge and a second bulge extending in opposite directions;
the first bulge being correspondingly embedded into the first chute, and the second bulge being correspondingly embedded into the second chute.

One technical effect of the present disclosure is as follows.

In the direct drive transmission system of the present disclosure, the primary assembly includes a connection unit, a first primary unit, and a second primary unit, and the secondary assembly includes a first secondary unit and a second secondary unit. The primary assembly can be firmly fixed to a to-be-fixed structure through the connection unit, and the to-be-fixed structure is, for example, the stator, the support or the like. The fixing manner is simple, assembly is easy, stability of fixation of the primary unit is ensured, and overall structural strength of the direct drive transmission system is improved.

Further, the connection unit includes a first end and a second end opposite to each other, a plurality of first primary units are sequentially distributed on the first end of the connection unit, a plurality of second primary units are sequentially distributed on the first end of the connection unit, the first primary unit faces the first secondary unit, the second primary unit faces the second secondary unit, a first magnetic field loop is formed between the first primary unit and the second secondary unit, and a second magnetic field loop is formed between the second primary unit and the second secondary unit. Since the first magnetic field loop and the second magnetic field loop are formed between the primary assembly and the secondary assembly, electromagnetic thrust on the secondary assembly is greatly improved, and the dynamic performance is better.

### BRIEF DESCRIPTION OF DRAWINGS

FIG. 1 is a schematic structural diagram of a direct drive transmission system according to an embodiment of the present disclosure;

FIG. 2 is a side view of the direct drive transmission system according to an embodiment of the present disclosure;

FIG. 3 is a schematic diagram of a position relationship between a primary assembly and a secondary assembly of the direct drive transmission system according to an embodiment of the present disclosure; and

FIG. 4 is an enlarged view of details of at a part A in FIG. 3.

In the drawings, 100. first magnetic field loop; 200. second magnetic field loop; 11. connection unit; 12. first primary unit; 121. first iron core; 122. first coil; 13. second primary unit; 131. second iron core; 132. second coil; 21. first secondary unit; 211. first magnetic yoke; 212. first magnet; 22. second secondary unit; 221. second magnetic yoke; 222. second magnet; 3. rotor; 31. groove; 4. support; 5. base; 6. bolt; 71. slider; 711. first chute; 712. second chute; 72. guide rail; 721. first bulge; 722 second bulge.

### DESCRIPTION OF EMBODIMENTS

Various exemplary embodiments of the present disclosure are now described in detail below with reference to the accompanying drawings. It is to be noted that, unless otherwise specified, relative arrangement, numerical expressions, and numerical values of components and steps set forth in the embodiments do not limit the scope of the present disclosure.

Embodiments of the present disclosure will be described in detail below. Examples of the embodiments are shown in the accompanying drawings. The same or similar reference numerals indicate the same or similar elements or elements having the same or similar functions. The embodiments described below with reference to the accompanying drawings are illustrative, are used only to explain the present disclosure, and cannot be understood as a limitation on the present disclosure. All other embodiments acquired by those of ordinary skill in the art without creative efforts based on the embodiments in the present disclosure shall fall within the protection scope of the present disclosure.

Features modified by the terms “first” and “second” in the specification and claims of the present disclosure may indicate or implicitly include one or more such features. In the description of the present disclosure, “a plurality of” means two or more than two, unless expressly specified otherwise. In addition, “and/or” in the specification and claims indicates at least one of the connected objects, and the character “/” generally indicates that associated objects before and after it are in an “or” relationship.

In the description of the present disclosure, it is to be understood that the orientation or position relationships indicated by the technical terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, etc. are based on the orientation or position relationships shown in the accompanying drawings and are only intended to facilitate the description of the present disclosure and simplify the description, rather than indicating or implying that the apparatus or element referred to must have a particular orientation or be constructed and operated in a particular orientation, and therefore cannot to be interpreted as limitations on the present disclosure.

In the description of the present disclosure, it is to be noted that, unless specifically stated and limited, the technical terms “mount,” “couple”, and “connect” should be understood in a broad sense, such as, a fixed connection, a detachable connection, or an integral connection; a mechanical connection or an electrical connection; a direct connection, an indirect connection through an intermediate medium, an internal connection of two elements, or an interaction of two elements. For those of ordinary skill in the art, the specific meanings of the above terms in the present disclosure can be understood on case-by-case.

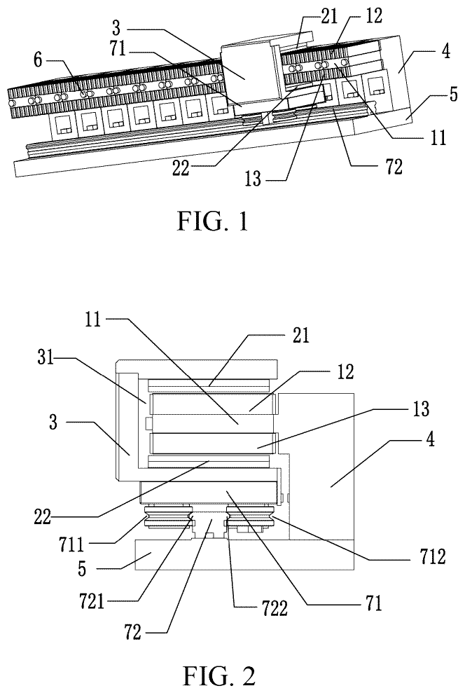

As shown in FIG. 1 to FIG. 4, the present disclosure provides a direct drive transmission system for realizing movement of a work table fixed to a rotor 3 in accordance with a preset trajectory, for example, in accordance with a linear trajectory. Certainly, a movement trajectory of the work table may also be set according to an actual requirement. The movement trajectory may be, but is not limited to, a linear trajectory.

Specifically, referring to FIG. 1 and FIG. 2, the direct drive transmission system includes a primary assembly and a secondary assembly. The primary assembly includes a connection unit 11, a first primary unit 12, and a second primary unit 13. The secondary assembly includes a first secondary unit 21 and a second secondary unit 22. The connection unit 11 is configured to fix the primary assembly to structures such as a support 4 and a stator, so that the secondary unit drives the rotor 3 and then drives the work table to stably move.

Further specifically, the connection unit 11 includes a first end and a second end opposite to each other, a plurality of first primary units 12 are sequentially distributed on the first end of the connection unit 11, a plurality of second primary units 13 are sequentially distributed on the first end of the connection unit 11, and the connection unit 11 is configured to fix the primary assembly. On the one hand, a distribution form of the primary assembly is improved and optimized, and a distribution area of the primary assembly is increased, which helps to form two magnetic field loops between the primary assembly and the secondary assembly, so as to better improve the electromagnetic thrust on the secondary assembly, thereby helping to improve the dynamic performance of the direct drive transmission system.

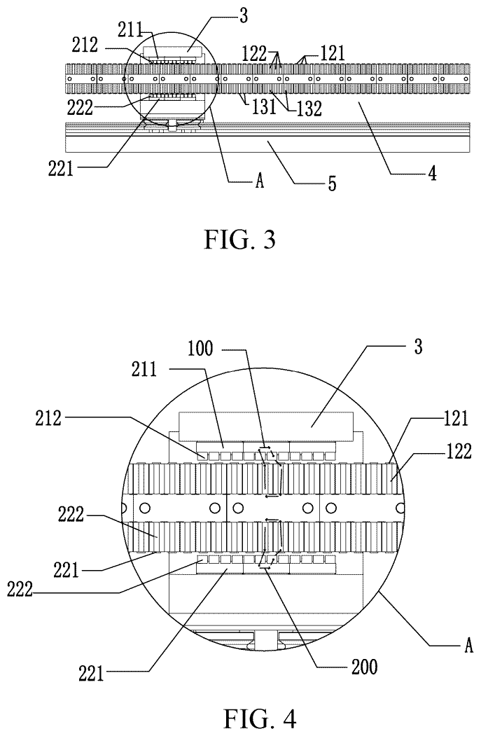

Referring to FIG. 3 and FIG. 4, the secondary assembly is movable relative to the primary assembly, the first primary unit 12 faces the first secondary unit 21, the second primary unit 13 faces the second secondary unit 22, a first magnetic field loop 100 is formed between the first primary unit 12 and the second secondary unit 22, and a second magnetic field loop 200 is formed between the second primary unit 13 and the second secondary unit 22. The specific structure of the secondary assembly corresponds to the specific structure of the primary assembly, so as to ensure that the secondary assembly is subjected to strong and stable electromagnetic thrust.

Therefore, in the direct drive transmission system of the present disclosure, the primary assembly includes a connection unit 11, a first primary unit 12, and a second primary unit 13, and the secondary assembly includes a first secondary unit 21 and a second secondary unit 22. The primary assembly can be firmly fixed to a to-be-fixed structure through the connection unit 11, and the to-be-fixed structure is, for example, the stator, the support 4 or the like, which is fixed in a simple manner, is easy to assemble, helps to ensure stability of fixation of the primary unit, and improves overall structural strength of the direct drive transmission system.

Further, the connection unit 11 includes a first end and a second end opposite to each other, a plurality of first primary units 12 are sequentially distributed on the first end of the connection unit 11, a plurality of second primary units 13 are sequentially distributed on the first end of the connection unit 11, the first primary unit 12 faces the first secondary unit 21, the second primary unit 13 faces the second secondary unit 22, a first magnetic field loop 100 is formed between the first primary unit 12 and the second secondary unit 22, and a second magnetic field loop 200 is formed between the second primary unit 13 and the second secondary unit 22. Since the first magnetic field loop 100 and the second magnetic field loop 200 are formed between the primary assembly and the secondary assembly, electromagnetic thrust on the secondary assembly is greatly improved, and the dynamic performance is better.

Optionally, each of the first primary units 12 includes a first iron core 121 and a first coil 122;
one end of the first iron core 121 is fixed to the first end of the connection unit 11, and the first coil 122 sleeves the other end of the first iron core 121;
and/or each of the second primary units 13 includes a second iron core 131 and a second coil 132;
one end of the second iron core 131 is fixed to the second end of the connection unit 11, and the second coil 132 sleeves the other end of the second iron core 131.

It is to be noted that adjacent primary units are spaced at interval. The first primary unit 12 is required to extend in a direction of a preset movement trajectory of the rotor 3, so as to ensure accuracy of movement of the rotor 3. At the same time, the second primary unit 13 is also required to extend in the direction of the preset movement trajectory of the rotor 3, so as to ensure accuracy of movement of the rotor 3. The first primary unit 12 and the second primary unit 13 extend in a same direction, which ensures electromagnetic thrust on the secondary assembly and also helps to ensure stability of movement of the secondary assembly relative to the primary assembly.

In addition, during the movement of the secondary assembly relative to the primary assembly, the secondary unit can better mate with the primary unit, so that a magnetic field loop is formed between the secondary assembly and the primary assembly, which ensures electromagnetic thrust on the secondary assembly and enables the secondary assembly to move more smoothly under interaction between the magnetic field loop and the primary assembly.

In the above embodiment, structures of the first primary unit 12 and the second primary unit 13 are simplified, and distribution manners of the first primary unit 12 and the second primary unit 13 are optimized, so as to better optimize the structure of the direct drive transmission system and also help to improve stability of mating between the primary assembly and the secondary assembly.

Optionally, the first iron core 121, the connection unit 11, and the second iron core 131 are formed into one piece. Firstly, this enables the structure of the primary assembly to be very simple and helps to save machining costs. Secondly, stability of connection of the first primary unit 12 and the second primary unit 13 with the connection unit 11 is ensured, and overall structural strength and reliability of the direct drive transmission system is also ensured. Thirdly, the first coil 122 can quickly sleeve an outer side of the first iron core 121 and the second coil 132 can quickly sleeve an outer side of the second iron core 131, an assembly speed of the primary assembly is increased, and machining efficiency of the direct drive transmission system is improved.

Optionally, the first secondary unit 21 includes a first magnetic yoke 211 and first magnets 212. An even number of first magnets 212 are arranged on the first magnetic yoke 211, adjacent first magnets 212 have different polarity, and the first magnets 212 face the first iron core 121.

The second secondary unit 22 includes a second magnetic yoke 221 and second magnets 222. An even number of second magnets 222 are arranged on the second magnetic yoke 221, adjacent second magnets 222 have different polarity, and the second magnets 222 face the second iron core 131.

The even number of the magnets are provided to ensure that a stable magnetic field loop can be formed between the primary assembly and the secondary assembly during movement of the secondary assembly. On the one hand, the first magnets 212 are fixed to the first magnetic yoke 211, and the second magnets 222 are fixed to the second magnetic yoke 221, which are fixed in a relatively simple manner.

In some embodiments, preset distances are formed respectively between two adjacent first magnets 212 and between two adjacent second magnets 222, so as to facilitate the formation of the magnetic field loop between the primary assembly and the secondary assembly.

Referring to FIG. 3 and FIG. 4, magnetic flux sequentially passes through the first one of the first magnets 212, the first iron core 121, the adjacent second one of the first magnets 212, and the first magnetic yoke 211 and then flows into the first one of the first magnets 212 to form the first magnetic field loop 100. At the same time, the magnetic flux sequentially passes through the first one of the second magnets 222, the second iron core 131, the adjacent second one of the second magnets 222, and the second magnetic yoke 221 and then flows into the first one of the second magnets 222 to form the second magnetic field loop 200, so that the direct drive transmission system can form strong electromagnetic thrust and have better dynamic performance.

Optionally, the direct drive transmission system further includes a rotor 3, the rotor 3 is provided with a groove 31, the groove 31 includes a first inner side surface and a second inner side surface opposite to each other, the first secondary unit 21 is arranged on the first inner side surface, and the second secondary unit 22 is arranged on the second inner side surface. The structure of the rotor 3 is designed reasonably, which helps to firmly arrange the secondary assembly on the rotor 3, also simplifies a mating structure of the primary assembly and the secondary assembly, ensures that the magnetic field loop formed between the primary assembly and the secondary assembly has higher electromagnetic thrust to better drive the secondary assembly to move according to the preset trajectory, and also helps to improve stability of the secondary assembly during the movement.

In the embodiment of the present disclosure, at least part of the primary assembly is embedded into the groove 31. Certainly, the primary assembly may be wholly embedded into the groove 31 to better increase a mating area between the primary assembly and the secondary assembly to ensure strength and stability of the electromagnetic thrust on the secondary assembly.

Optionally, referring to FIG. 2, a base 5 and a support 4 are further included. The support 4 is fixed to the base 5, and the connection unit 11 is fixed to the support 4.

In the above embodiment, the support 4 can better fix the primary assembly, which ensures stability of the primary assembly, while the base 5 helps to stably fix the support 4 to a preset position, so as to ensure stability and reliability of the whole direct drive transmission system.

It is to be noted that the support 4 is equivalent to the stator in the present disclosure, and the primary assembly is fixed to the support 4, which has higher stability.

Optionally, the connection unit 11 is provided with a plurality of spaced mounting holes, and a bolt 6 passes through the mounting hole to fix the primary assembly to the support 4. In this way, the primary assembly is fixed to the support 4 in a relatively simple manner, it is easy to realize quick assembly between the primary assembly and the support 4, and assembly efficiency is improved. The mounting holes are punched on the connection unit 11, which are formed in a relatively simple manner.

In some other embodiments, the connection unit 11 may also be clamped to the support 4 by a clamping structure. Certainly, the connection unit 11 may be soldered directly to the support 4, thereby significantly improving stability and reliability of connection between the primary assembly and the support 4.

Optionally, referring to FIG. 2 to FIG. 4, the direct drive transmission system further includes a limiting assembly, and the limiting assembly includes a slider 71 and a guide rail 72.

The guide rail 72 is fixed to the base 5, the first primary units 12 or the second primary units 13 are distributed along a first direction, and the guide rail 72 extends along the first direction. The slider 71 is fixed to the rotor 3, and the slider 71 is mounted on the guide rail 72 and movable along an extension direction of the guide rail 72.

It is to be noted that the guide rail 72 moves along a distribution direction of the first primary units 12 or the second primary units 13, which helps to realize that the secondary assembly drives the work table to move according to the preset trajectory and improves accuracy of the movement of the work table.

In addition, the guide rail 72 mates with the slider 71, which helps to accurately guide the movement direction of the rotor 3, and also helps to reduce movement resistance of the rotor 3, so that the rotor 3 can drive the work table to move accurately and stably along the preset trajectory.

Optionally, at least part of the first direction is a linear direction. This enables the rotor 3 to drive the work table to move along a linear direction, which meets a machining requirement of the work table and is easy to operate.

In some other embodiments, part of the first direction may be an arc direction. For example, when the work table is required to turn, the guide rail 72 distributed along a semi-arc direction and the primary assembly distributed along the semi-arc direction may be arranged, which is required to be arranged according to the preset trajectory of the work table, so as to better meet a movement requirement of the work table and improve driving efficiency and effect of the direct drive transmission system.

Optionally, the slider 71 includes a first chute 711 and a second chute 712 opposite to each other, and the guide rail 72 includes a first bulge 721 and a second bulge 722 extending in opposite directions.

The first bulge 721 is correspondingly embedded into the first chute 711, and the second bulge 722 is correspondingly embedded into the second chute 712.

In the above embodiment, the first bulge 721 is correspondingly embedded into the first chute 711, and the second bulge 722 is correspondingly embedded into the second chute 712, which can accurately limit the rotor 3, and also help to ensure stability of the rotor 3 during the movement.

Therefore, the direct drive transmission system according to the present disclosure is reasonably designed, is fixed in a simple manner, has good dynamic performance, is simple in structure, and has low costs.

It may be understood that the above embodiments are only exemplary embodiments intended to illustrate the principle of the present disclosure, but the present disclosure is not limited thereto. For those of ordinary skill in the art, various variations and improvements can be made without deviating from the spirit and essence of the present disclosure, and these variations and improvements are also regarded as the protection scope of the present disclosure.

1. A direct drive transmission system, comprising a primary assembly and a secondary assembly, wherein
the primary assembly comprises a connection unit, a first primary unit, and a second primary unit; and the secondary assembly comprises a first secondary unit and a second secondary unit;
the connection unit comprises a first end and a second end opposite to each other; a plurality of first primary units is sequentially distributed on the first end of the connection unit, a plurality of second primary units is sequentially distributed on the second end of the connection unit, the connection unit is configured to fix the primary assembly; and
the secondary assembly is movable relative to the primary assembly, the first primary unit faces the first secondary unit, the second primary unit faces the second secondary unit, a first magnetic field loop is formed between the first primary unit and the first secondary unit, and a second magnetic field loop is formed between the second primary unit and the second secondary unit.

2. The direct drive transmission system according to claim 1, wherein each of the plurality of first primary units comprises a first iron core and a first coil;
one end of the first iron core is fixed to the first end of the connection unit, and the first coil is sleeved on the other end of the first iron core;
and/or each of the plurality of second primary units comprises a second iron core and a second coil;
one end of the second iron core is fixed to the second end of the connection unit, and the second coil is sleeved on the other end of the second iron core.

3. The direct drive transmission system according to claim 2, wherein the first iron core, the connection unit, and the second iron core are formed into one piece.

4. The direct drive transmission system according to claim 2, wherein the first secondary unit comprises a first magnetic yoke and first magnets; an even number of first magnets are arranged on the first magnetic yoke, adjacent first magnets have different polarity, and the first magnets face the first iron core; and
the second secondary unit comprises a second magnetic yoke and second magnets; an even number of second magnets are arranged on the second magnetic yoke, adjacent second magnets have different polarity, and the second magnets face the second iron core.

5. The direct drive transmission system according to claim 4, further comprising a rotor, wherein
the rotor is provided with a groove, the groove comprises a first inner side surface and a second inner side surface opposite to each other, the first secondary unit is arranged on the first inner side surface, and the second secondary unit is arranged on the second inner side surface; and
at least part of the primary assembly is embedded into the groove.

6. The direct drive transmission system according to claim 5, further comprising a base and a support, wherein the support is fixed to the base, and the connection unit is fixed to the support.

7. The direct drive transmission system according to claim 6, wherein the connection unit is provided with a plurality of mounting holes which is spaced at intervals, a bolt passes through a mounting hole of one of the plurality of mounting holes to fix the primary assembly to the support.

8. The direct drive transmission system according to claim 6, further comprising a limiting assembly, wherein
the limiting assembly comprises a slider and a guide rail;
the guide rail is fixed to the base, the first primary units or the second primary units is distributed along a first direction, the guide rail extends along the first direction;
the slider is fixed to the rotor, mounted on the guide rail and is movable along an extension direction of the guide rail.

9. The direct drive transmission system according to claim 8, wherein at least part of the first direction is a linear direction.

10. The direct drive transmission system according to claim 9, wherein the slider comprises a first chute and a second chute opposite to each other, and the guide rail comprises a first bulge and a second bulge that extend in opposite directions,
the first bulge is correspondingly embedded into the first chute, and the second bulge is correspondingly embedded into the second chute.
